(19) United States
(12) Patent Application Publication
(10) Pub. No.: US 2023/0348791 A1
(43) Pub. Date: Nov. 2, 2023

(54) Method for selective decarboxylation of oxygenates

(71) Applicant: TOPSOE A/S, Kgs. Lyngby (DK)

(72) Inventors: Magnus Zingler STUMMANN, Copenhagen OE (DK); Jostein GABRIELSEN, Rødovre (DK)

(73) Assignee: TOPSOE A/S, Kgs. Lyngby (DK)

(21) Appl. No.: 18/002,177

(22) PCT Filed: Jun. 24, 2021
(86) PCT No.: PCT/EP2021/067437

§ 371 Date: Dec. 16, 2022

(30) Foreign Application Priority Data
Jun. 26, 2020 (EP) 20182560.1

(51) Int. Cl. C10G 3/00; C10G 65/12

(52) U.S. Cl. CPC C10G 3/46; C10G 3/52; C10G 65/12; C10G 2400/08; C10G 2300/301; C10G 2300/4006; C10G 2300/4012; C10G 2300/4018; C10G 2300/42

(57) ABSTRACT

A process plant and a method for producing a hydrocarbon mixture suitable for use as an aviation fuel having an end-boiling point according to ASTM D86 below 300° C. from a decarboxylation feedstock being a feedstock including fatty acid esters and/or triglycerides and including C18 side-chains, to a deoxygenated hydrocarbon mixture by directing the decarboxylation feedstock to contact a material catalytically active in decarboxylation under decarboxylation conditions where the ratio between deoxygenation by formation of carbon oxides and deoxygenation by formation of water is at least 1.5:1, 2:1 or 3:1, as measured by the ratio of C17 paraffins to C18 paraffins in the deoxygenated hydrocarbon mixture, with the associated benefit of such a decarboxylation based method selectively reducing the product carbon length by a single carbon atom, compared to a hydrodeoxygenation based method, which is beneficial for processes requiring a moderate reduction of end boiling point.

Conversion of renewables in hydroprocessing has so far been focused on making diesel, since the paraffins corresponding to the typical fatty acids of biological materials such as vegetable oils and animal fats (C14, C16 and C18) boil from 250° C. to 320° C., corresponding well with typical diesel products boiling from 150° C. to 380° C. Aviation fuel products are required to have a boiling range according to ASTM 86 of 120° C. to 300° C., which means that the heavy part of a paraffins from renewable feedstocks needs to be converted into lighter materials to produce only aviation fuel. The present disclosure relates to a process having a high yield of renewable aviation fuel obtained by a process selective towards decarboxylation.

The standard controlling the quality of aviation fuel originating from hydroprocessed oxygenates such as esters and fatty acids is ASTM D7566, A2.1, which inter alia specifies the boiling point curve and composition. Specifically, the standard requires an amount of low boiling product by requiring T₁₀, i.e. the temperatures at which 10% has been distilled according to ASTM D86, to be below 205° C. The final boiling point (FBP) is specified as below 300° C., according to ASTM D86, which means that all material distilling above 300° C. according to ASTM D86 needs to be converted into lighter components to fall into the aviation fuel range. Finally, the amount of aromatics is limited to be below 0.5% wt. Most of these properties can be easily met by hydrotreating, hydrocracking and fractionation, but especially hydrocracking would be related to a loss of yield.

Now according to the present disclosure, it is proposed to carry out aviation fuel production by a process having increased selectivity towards decarboxylation over hydrodeoxygenation, producing C17 hydrocarbons boiling in the aviation fuel range instead of C18 hydrocarbons which boil above the aviation fuel range. This may be carried out in the presence of a catalytically active material comprising nickel as the only or dominant active metal and optionally after saturation of double bonds in the feedstock, or by other decarboxylation specific processes such as those known to the skilled person i.a. from EP1681337B. The benefit will be a surprisingly low yield loss and low hydrogen consumption, compared to a process converting C18 hydrocarbons to C17 hydrocarbons by hydrocracking.

In the following the term stage shall be used for a section of the process, in which no separation is performed.

In the following the abbreviation ppmₘₒₗₐᵣ shall be used to signify atomic parts per million.

In the following the abbreviation ppmᵥ shall be used to signify volumetric parts per million, e.g. molar gas concentration.

In the following the abbreviation % wt shall be used to signify weight percentage.

In the following the term renewable feedstock or hydrocarbon shall be used to indicate a feedstock or hydrocarbon originating from biological sources or waste recycle. Recycled waste of fossil origin such as plastic shall also be construed as renewable.

In the following the term deoxygenation shall be used to signify removal of oxygen from oxygenates by formation of water in the presence of hydrogen, as well as removal of oxygen from oxygenates by formation of carbon oxides in the presence of hydrogen.

In the following the term hydrodeoxygenation shall be used to signify removal of oxygen from oxygenates by formation of water in the presence of hydrogen.

In the following the term decarboxylation shall be used to signify removal of oxygen from oxygenates by formation of carbon oxides in the presence of hydrogen.

In the following, the term topology of a molecular sieve is used in the sense described in the “Atlas of Zeolite Framework Types,” Sixth Revised Edition, Elsevier, 2007, and three letter framework type codes are used in accordance herewith.

In the following the concentration of olefins shall be the total mass of oxygenate molecules in a mixture having at least one C═C double bond, divided with the total of hydrocarbonaceous molecules (hydrocarbons, oxygenates and hydrocarbonaceous molecules comprising other heteroatoms).

In the following the terminology such as C18—in general Cn, where n is a number—shall be construed as a hydrocarbon structure comprising 18 (or n) carbon atoms. C18 side chains shall be construed as a chemically characteristic sub-structure comprising 18 carbon atoms, e.g. one of the fatty acids of a tri-glyceride molecule being stearic acid or oleic acid (to give two examples of linear C18 fatty acids).

A broad aspect of the present disclosure relates to a method for producing a hydrocarbon mixture having an end-boiling point according to ASTM D86 below 300° C. and being suitable for use as an aviation from a decarboxylation feedstock comprising fatty acid esters and/or triglycerides wherein at least 40% of the carbon atoms of the decarboxylation feedstock are contained in C18 side-chains, by converting said decarboxylation feedstock in in the presence of a material catalytically selective towards decarboxylation such that the ratio between deoxygenation by formation of carbon oxides and deoxygenation by formation of water is at least 1.5:1, 2:1 or 3:1, as measured by the ratio of C17 paraffins to C18 paraffins in the deoxygenated hydrocarbon mixture, with the associated benefit of such a decarboxylation based method selectively reducing the product carbon length by a single carbon atom, compared to a hydrodeoxygenation based method, which is beneficial for processes requiring a moderate reduction of end boiling point.

In a further embodiment decarboxylation conditions involve a temperature in the interval 250-400° C., a pressure in the interval 30-150 bar, and a liquid hourly space velocity (LHSV) in the interval 0.1-2 and wherein the material catalytically active in decarboxylation comprises nickel optionally in combination with other metals, supported on a carrier comprising one or more refractory oxides, such as alumina, silica or titania, with the associated benefit of such process conditions being well suited for selective decarboxylation conversion of a renewable feedstock.

In a further embodiment at least 40%, 60% or 80% of the carbon of said decarboxylation feedstock is contained in C18 side chains, with the associated benefit of such a feedstock being especially well suited for production of product boiling in the aviation fuel range using a material catalytically active in decarboxylation.

In a further embodiment the material catalytically active in decarboxylation comprises more than 5 wt % Ni, more than 10 wt % Ni or more than 15 wt % Ni and less than 30 wt % Ni, less than 50 wt % Ni or less than 70 wt % Ni and less than 1 wt %, 0.5 wt % or less than 0.1 wt % Co, Mo and W such as 0 wt % Co, Mo and W, with the associated benefit of such a material being selective towards decarboxylation while having a moderate cost.

In a further embodiment said decarboxylation feedstock is a saturated decarboxylation feedstock, comprising less than less than 10 wt % or 1 wt % olefinic oxygenates, with the associated benefit of reducing the need for careful monitoring of decarboxylation conditions to avoid deactivation of the material catalytically active in decarboxylation by deposition of carbon.

In a further embodiment said decarboxylation feedstock is provided as the product of a hydrogenation reaction, receiving a raw oxygenate feedstock comprising at least 10 wt % or 50 wt % olefinic oxygenates and selectively hydrogenating olefinic oxygenates under olefin pre-hydrogenation conditions, to provide said saturated decarboxylation feedstock, with the associated benefit of minimizing the exposure of the material catalytically active in decarboxylation to olefins, which may cause carbon deposits on the catalytically active material. The selective pre-hydrogenation prior to decarboxylation over a material having NiS as the only or dominating active phase is especially beneficial, as such a material has a higher propensity for formation of carbon deposits in the presence of olefins.

In a further embodiment pre-hydrogenation conditions involve a temperature in the interval from 150 ° C. to 220° C., 250° C. or 280° C., a pressure in the interval 30-150 bar, and a liquid hourly space velocity (LHSV) in the interval 0.1-2 and wherein the material catalytically active in pre-hydrogenation comprises 5 wt %-20 wt % molybdenum and/or tungsten, in combination with 1 wt % to 5 wt %nickel and/or cobalt, supported on a carrier comprising one or more refractory oxides, such as alumina, silica or titania, with the associated benefit of such process conditions being well suited for hydrogenation of olefinic bonds, while minimizing the hydrodeoxygenation of the renewable feedstock.

In a further embodiment the deoxygenated hydrocarbon mixture is separated according to boiling point, to provide a hydrocracked intermediate aviation fuel having T10 below 205° C. and final boiling point below 300° C. according to ASTM D86, with the associated benefit of the product of such a process fulfilling boiling point specifications of the renewable aviation fuel specification ASTM D7566, even where the decarboxylation process is not 100% selective.

In a further embodiment the total volume of hydrogen sulfide relative to the volume of molecular hydrogen in the gas phase of the total stream directed to contact the material catalytically active in decarboxylation is at least 50 ppmᵥ, 100 ppmᵥ or 200 ppmᵥ, optionally originating from an added stream comprising one or more sulfur compounds, such as dimethyl disulfide or fossil fuels, with the associated benefit of ensuring stable operation of a material catalytically active in decarboxylation comprising a sulfided base metal, if the feedstock comprises an insufficient amount of sulfur.

In a further embodiment said decarboxylation feedstock comprises at least 50% wt triglycerides or fatty acids, with the associated benefit of such a feedstock being highly suited for providing a aviation fuel with excellent properties.

In a further embodiment the method further comprises a hydrocracking step, under active hydrocracking conditions, where the deoxygenated hydrocarbon mixture or a mixture derived therefrom is directed to contact a material catalytically active in hydrocracking, with the associated benefit of such a step allowing the hydrocarbon mixture suitable for use as an aviation fuel to be produced from the deoxygenated hydrocarbon, even if it comprises longer hydrocarbons than C17, due to either the nature of the decarboxylation feedstock or the selectivity of the decarboxylation step. The hydrocracking step may be positioned upstream decarboxylation in a socalled reverse staging layout or it may be positioned downstream decarboxylation, either immediately downstream decarboxylation or after a separation step, such as a simple gas/liquid separation or a fractionation.

In a further embodiment hydrocracking conditions involve a temperature in the interval 300-450° C., a pressure in the interval 30-150 bar, and a liquid hourly space velocity

(LHSV) in the interval 0.5-8 and wherein the material catalytically active in hydrocracking comprises an active metal taken from the group comprising platinum, palladium, nickel, cobalt, tungsten and molybdenum, preferably one or more elemental noble metals such as platinum or palladium, an acidic support being one or more of an amorphous acidic oxides such as silica-alumina and a molecular sieve showing high cracking activity, such as molecular sieves having a topology taken from the group of MFI, BEA and FAU and an amorphous refractory support comprising one or more oxides taken from the group comprising alumina, silica and titania, with the associated benefit of such conditions and materials being a cost effective and selective process for adjusting the cold flow properties of product. If hydrocracking is positioned immediately downstream decarboxylation the active metal(s) will preferably be one or more sulfided base metals nickel, cobalt, tungsten and molybdenum whereas if hydrocracking is positioned after a separation step, the active metals will preferably be one or more elemental noble metals such as platinum or palladium, unless a sulfur source is added to ensure sulfidation.

In a further embodiment the method further comprises an isomerization step, under active isomerization conditions involves a temperature in the interval 250-350° C., a pressure in the interval 30-150 bar, and a liquid hourly space velocity (LHSV) in the interval 0.5-8 and wherein the material catalytically active in isomerization comprises an active metal taken from the group comprising platinum, palladium, nickel, cobalt, tungsten and molybdenum, preferably one or more elemental noble metals such as platinum or palladium, an acidic support preferably a molecular sieve, more preferably having a topology taken from the group comprising MOR, FER, MRE, MWW, AEL, TON and MTT and an amorphous refractory support comprising one or more oxides taken from the group comprising alumina, silica and titania, with the associated benefit of such conditions and materials being a cost effective and selective process for adjusting the cold flow properties of product. As for hydrocracking, isomerization may take place immediately downstream decarboxylation or downstream a separation section. If isomerization is positioned immediately downstream decarboxylation the active metal(s) will preferably be one or more sulfided base metals nickel, cobalt, tungsten and molybdenum whereas if isomerization is positioned after a separation step, the active metals will preferably be one or more elemental noble metals such as platinum or palladium, unless a sulfur source is added to ensure sulfidation.

The same considerations regarding active metals applies for the material catalytically active in isomerization as for the material catalytically active in hydrocracking.

A further aspect of the present disclosure relates to a process plant for production of a hydrocarbon fraction from an decarboxylation feedstock, said process plant comprising a decarboxylation section, a hydrocracking section and a fractionation section, said process plant being configured for directing the decarboxylation feedstock in combination with an amount of a hydrocracked intermediate product to the decarboxylation section to provide a deoxygenated hydrocarbon mixture , separating the deoxygenated hydrocarbon mixture in said fractionation section to provide at least two fractions, including a low boiling product fraction and a high boiling product fraction, directing at least an amount of the high boiling product fraction to the hydrocracking section to provide a hydrocracked intermediate product, directing at least an amount of said hydrocracked intermediate product to the decarboxylation section , wherein said decarboxylation section contains a catalytically active material comprising less than 1 wt %, 0.5 wt % or 0.1wt % Co, Mo or W, with the associated benefit of such a process plant being suited for carrying out the disclosed process for cost effective and selective production of aviation fuel in compliance with specification ASTM D7566, Appendix A2.

The processes described in the present disclosure receives a renewable feedstock and/or an oxygenate feedstock which comprises one or more oxygenates taken from the group consisting of triglycerides, fatty acids, esters, resin acids, ketones, aldehydes, alcohols, phenols and aromatic carboxylic acids where said oxygenates originate from one or more of a biological source, a gasification process, a pyrolysis process, Fischer-Tropsch synthesis, methanol based synthesis or a further synthesis process, especially obtained from a raw material of renewable origin, such as originating from plants, algae, animals, fish, vegetable oil refining, domestic waste, used cooking oil, plastic waste, rubber waste or industrial organic waste like tall oil or black liquor.

Some of these feedstocks may contain aromatics; especially products derived by pyrolysis or other processes from e.g. lignin and wood or waste products from e.g. frying oil. Depending on source, the oxygenate feedstock may comprise from 1 wt % to 40 wt % oxygen. Biological sources will typically comprise around 10 wt %, and derivation products from 1 wt % to 20 wt % or even 40 wt %.

For the conversion of renewable feedstocks and/or oxygenate feedstocks into hydrocarbon transportation fuels, the feedstocks are, together with hydrogen, directed to contact a material catalytically active in hydrotreatment, especially hydrodeoxygenation. In addition to hydrodeoxygenation the catalytically active material will often also be active in decarboxylation, where oxygen is removed as CO₂ instead of as H₂O. Decarboxylation is often less preferred than hydrodeoxygenation as decarboxylation will involve a loss of yield, and in addition, although the decarboxylation reaction as such consumes less hydrogen than the hydrodeoxygenation reaction, CO₂ may to some extent be converted to CH₄, involving consumption of hydrogen. In addition, especially at elevated temperatures the catalytic hydrodeoxygenation process may have side reactions forming a heavy product e.g. from olefinic molecules in the feedstock. Such side reactions may be more prolific in the presence of catalytically active materials dominated by NiS. To moderate the release of heat, a liquid hydrocarbon may be added, e.g. a liquid recycle stream or an external diluent feed. If the process is designed for co-processing of fossil feedstock and renewable feedstock, it is convenient to use the fossil feedstock as diluent, since less heat is released during processing of fossil feedstock, as fewer heteroatoms are released and less olefins are saturated. In addition to moderating the temperature, the recycle or diluent also has the effect of reducing the potential of olefinic material to polymerize, which will form an undesired heavy fraction in the product. The resulting product stream will be a hydrodeoxygenated hydrocarbon mixture stream comprising hydrocarbons, typically n-paraffins, and sour gases such as CO, CO₂, H₂O, H₂S, NH₃ as well as light hydrocarbons, especially C3 and methane. For the present disclosure, the feedstock is preferably rich in triglycerides, fatty acid esters or fatty acid, which may release oxygen by decarboxylation.

Hydrodeoxygenation involves directing the feedstock to contact a catalytically active material typically comprising one or more sulfided base metals such as nickel, cobalt, tungsten or molybdenum, but possibly also elemental noble metals such as platinum and/or palladium, supported on a carrier comprising an inert support typically one or more refractory oxides, such as alumina, but possibly silica or titania, but other inert supports such as activated carbon are also used. The support is typically amorphous. The catalytically active material may comprise further components, such as boron or phosphorous. Effective conditions for hydrodeoxygenation typically involve a temperature in the interval 250-400° C., a pressure in the interval 30-150 bar, and a liquid hourly space velocity (LHSV) in the interval 0.1-2. Hydrodeoxygenation is typically exothermal, and with the presence of a high amount of oxygen, the process may involve intermediate cooling e.g. by quenching with cold hydrogen, feed or product. The feedstock may preferably contain an amount of sulfur to ensure sulfidation of the metals, unless noble metals are used, in order to maintain their activity. If the gas phase comprises less than 10, 50 or 200 ppmᵥ sulfur calculated as hydrogen sulfide, a sulfide donor, such as dimethyldisulfide (DMDS) may be added to the feed.

The hydrodeoxygenated hydrocarbon mixture will mainly be of same structure as the carbon skeleton of the feedstock oxygenates, i.e. if the feedstock comprises triglycerides, n-paraffins, but if a hydrocracking side reaction occurs the product may possibly be of a shorter length than the fatty acids. Typically, the hydrodeoxygenated hydrocarbon mixture will be dominated by linear alkanes having boiling point range (250° C. to 320° C.) and a freezing point (0° C. to 30° C.) unsuited for use as aviation fuel.

For the hydrodeoxygenated hydrocarbon mixture to be used as a fuel in practice, the freezing point must be adjusted. The freezing point is adjusted by isomerization of n--paraffins to i-paraffins, by directing the hydrodeoxygenated hydrocarbon mixture to contact a material catalytically active in isomerization

Isomerization involves directing the deoxygenated hydrocarbon mixture to contact a material catalytically active in isomerization. Effective conditions for isomerization typically involve a temperature in the interval 250-350° C., a pressure in the interval 30-150 bar, and a liquid hourly space velocity (LHSV) in the interval 0.5-8. Isomerization is substantially thermally neutral and consumes only hydrogen in hydrocracking side reactions, but a moderate amount of hydrogen is added in the isomerization section, as this is required for effective isomerization. When the active metal on the material catalytically active in isomerization is a noble metal, the hydrodeoxygenated hydrocarbon mixture is typically purified by gas/liquid separation to reduce the content of potential catalyst poisons to low levels such as levels of sulfur, nitrogen and carbon present in carbon oxides to below 1-10 ppmₘₒₗₐᵣ. When the active metal is a base metal the gas phase of the hydrodeoxygenated hydrocarbon mixture preferably contains at least 50 ppmᵥ sulfur calculated as hydrogen sulfide.

The material catalytically active in isomerization typically comprises an active metal (either elemental noble metals such as platinum and/or palladium or sulfided base metals such as nickel, cobalt, tungsten and/or molybdenum), an acidic support (typically a molecular sieve showing high shape selectivity, and having a topology such as MOR, FER, MRE, MWW, AEL, TON and MTT) and a typically amorphous refractory support (such as alumina, silica or titania, or combinations thereof). The catalytically active material may comprise further components, such as boron or phosphorous. Preferred isomerization catalysts comprise molecular sieves such as EU-2, ZSM-48, beta zeolite and combined beta zeolite and zeolite Y.

For the hydrodeoxygenated hydrocarbon mixture stream to be used as a aviation fuel fraction, the boiling point range may have to be adjusted. The boiling point is adjusted by hydrocracking of long paraffins to shorter paraffins, by directing the hydrodeoxygenated hydrocarbon mixture to contact a material catalytically active in hydrocracking.

Hydrocracking involves directing the hydrocarbons to contact a material catalytically active in hydrocracking. Effective conditions for hydrocracking typically involve a temperature in the interval 250-400° C., a pressure in the interval 30-150 bar, and a liquid hourly space velocity (LHSV) in the interval 0.5-4. As hydrocracking is exothermal, the process may involve intermediate cooling e.g. by quenching with cold hydrogen, feed or product. When the active metal on the material catalytically active in isomerization is a noble metal, the hydrodeoxygenated hydrocarbon mixture is typically purified by gas/liquid separation to reduce the content of potential catalyst poisons to low levels such as levels of sulfur, nitrogen and carbon present in carbon oxides to below 1-10 ppmₘₒₗₐᵣ. When the active metal is a base metal the gas phase of the hydrocarbons preferably contains at least 50 or 100 ppmᵥ sulfur calculated as hydrogen sulfide.

The material catalytically active in hydrocracking is of a nature similar to that of the material catalytically active in isomerization, and it typically comprises an active metal (either elemental noble metals such as platinum and/or palladium or sulfided base metals such as nickel, cobalt, tungsten and/or molybdenum), an acidic support (typically a molecular sieve showing high cracking activity, and having a topology such as MFI, BEA and FAU, but amorphous acidic oxides such as silica-alumina may also be used) and a refractory support (such as alumina, silica or titania, or combinations thereof). The difference to a material catalytically active in isomerization is typically the nature of the acidic support, which may be of a different structure (even amorphous silica-alumina) or have a different acidity e.g. due to silica:alumina ratio. The catalytically active material may comprise further components, such as boron or phosphorous. Preferred hydrocracking catalysts comprise molecular sieves such as ZSM-5, zeolite Y or beta zeolite.

While catalyst design and process design may adjust selectivity of the hydrocracking process, the nature of hydrocracking will involve some yield loss to light hydrocarbons, which will not be useful as aviation fuel, and possibly not even naphtha.

It has now been identified that a process with high selectivity towards decarboxylation of fatty acids and triglycerides may be beneficial in this respect. The required boiling point range (determined according to ASTM D86) for aviation fuel is T10<205° C. and FBP<300° C., which correspond to C8-C17 alkanes. As the majority of biological fatty acids have a predominance of C18 fatty acids, (typically 70-95 wt %), a high amount of C18 alkanes will be present if the deoxygenation reactions proceeds by hydrodeoxygenation. However, by selecting catalysts and processes favoring decarboxylation C18 fatty acids will be converted to C17 alkanes, which boil in the range required for aviation fuel.

Selectivity towards decarboxylation has been considered in the prior art, mainly from the assumption that this reaction consumes less hydrogen. The conversion of carbon oxides to methane has however been argued to add to the consumption of hydrogen, cancelling this assumed benefit to some extent. For the purpose of production of aviation fuel, it has however not been considered to employ selective decarboxylation to minimize yield loss by only removing a single carbon atom from the fatty acid chain.

Decarboxylation selectivity is known to be favored by use of catalytically active material comprising sulfided Ni, in the absence of other active metals. Unfortunately, the experience with such decarboxylation selective catalysts has widely been an increased tendency to formation of coke, resulting in catalyst deactivation limiting the lifetime of a catalyst loading. Without being bound by theory, it is believed that materials catalytically active in decarboxylation such as sulfided Ni are less active in hydrogen absorption and hydrogenation, thus favoring the decarboxylation reaction over the hydrogen consuming hydrodeoxygenation, but at the cost of increased propensity for dehydrogenation of olefins, resulting in formation of solid carbon. Accordingly, the long term stability of decarboxylation selective catalytically active materials has been a challenge.

It has now been identified that if a saturated oxygenate is directed to a catalytically active material having a high selectivity towards decarboxylation over hydrodeoxygenation, stable production of hydrocarbons boiling in the aviation fuel range is possible, with a higher yield, compared to hydrodeoxygenation in combination with hydrocracking.

The saturated oxygenate may preferentially be provided by pre-hydrogenation in the presence of a material active in hydrogenation, operated at low severity, to ensure that olefinic bonds are hydrogenated, without deoxygenation taking place. A material with high activity is preferred, as this will result in a low temperature, which results in hydrogenation of olefins being favored over hydrodeoxygenation of oxygenates. Examples of appropriate catalytically active materials for such pre-hydrogenation include the materials listed above, especially comprising a sulfided metal from Group 6 of the periodic system, such as Mo or W, in combination with a sulfided metal from Group 8, 9 or 10, such as Ni or Co. Effective conditions for olefin hydrogenation typically involve a temperature in the interval from 150° C. especially at start of run to 220° C., 250° C. or even 280° C. at end of run, a pressure in the interval 30-150 bar, and a liquid hourly space velocity (LHSV) in the interval 0.1-2. Olefin hydrogenation is exothermal, and with the presence of a high amount of olefins, the process may involve intermediate cooling e.g. by quenching with cold hydrogen, feed or recycled product. The feedstock may preferably contain an amount of sulfur to ensure sulfidation of the metals, in order to maintain their activity. If the gas phase comprises less than 10, 50 or 100 ppmᵥ sulfur calculated as hydrogen sulfide, a sulfide donor, such as dimethyldisulfide (DMDS) may be added to the feed.

Therefore, a process for providing an aviation fuel from oxygenates may beneficially be configured to involved pre-hydrogenation at low severity in the presence of an active material catalytically active in hydrogenation, such as NiMo on a refractive support, followed by deoxygenation under conditions and in the presence of a catalytically active material favoring decarboxylation over hydrodeoxygenation. Typically, such a process will be followed by an isomerization process, either employing a sulfided catalytically active material or, after separation of gases, a reduced catalytically active material comprising a noble metal, providing a hydroprocessed stream, comprising an aviation fuel fraction.

The hydrotreated stream may be directed to a fractionator (after appropriate removal of the gas phase in a separator train), and at least a gas fraction, an intermediate fraction and a bottoms fraction of the hydrotreated stream are withdrawn. All streams out of the fractionator have a very low level of water, hydrogen sulfide and ammonia. A bottoms fraction will be typically be present, which is too heavy for being used as aviation fuel.

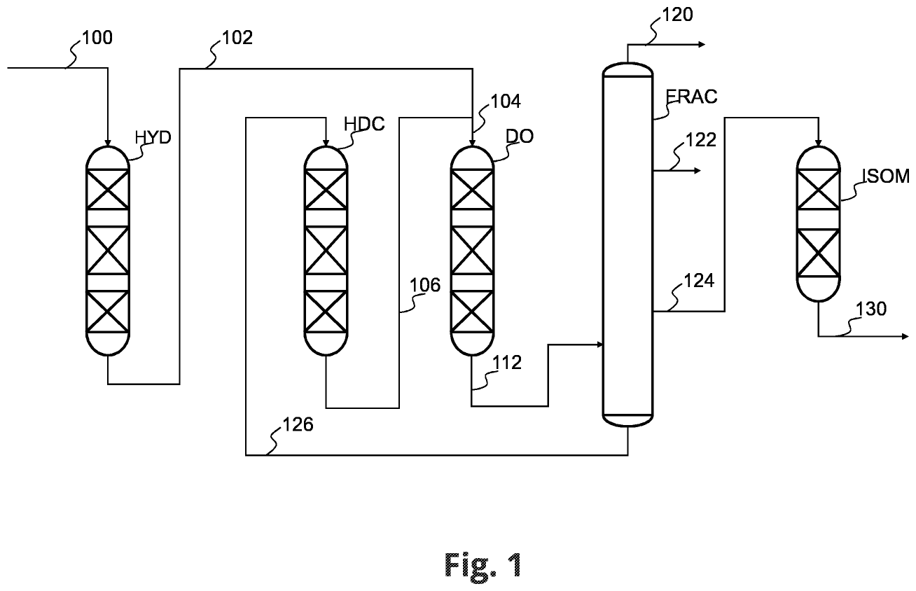

FIG. 1 is a simplified FIGURE showing a process layout for production of aviation fuel. A feedstock rich in oxygenates (100) is directed as a pre-hydrogenation feed stream together with an amount of a hydrogen rich stream (not shown) to a pre-hydrogenation section (PRE) where it contacts a material catalytically active in hydrogenation under olefin hydrogenation conditions, e.g. a sulfided NiMo catalyst supported on alumina typically operating below 250° C. This provides a pre-hydrogenated intermediate product (102). The pre-hydrogenated intermediate product (102) is combined with a hydrocracked bottom fraction (106) and directed as a deoxygenation feed (104) to a deoxygenation section (DO) comprising a material catalytically active in deoxygenation, such as a sulfided Ni catalyst supported on alumina and operating under deoxygenation conditions, providing a deoxygenated hydrocarbon mixture (112). The deoxygenated hydrocarbon mixture (112) is directed to a fractionation section (FRAC) shown for simplicity as a single unit, separating the hydrocracked intermediate product in a light overhead stream (120), a naphtha stream (122), a hydrotreated intermediate kerosene fraction (124) and a bottom fraction (126), as well as water and recycled hydrogen gas (not shown). An amount of the bottom fraction (126) is directed as a recycle stream, which together with hydrogen (not shown) is directed to a hydrocracking section (HDC) comprising a material catalytically active in hydrocracking operating under effective hydrocracking conditions. The hydrotreated intermediate kerosene fraction is directed to an isomerization section.

To control the temperature in the deoxygenation section, an amount of deoxygenated hydrocarbon mixture (112) may also be cooled, separated in gas and liquid fractions by flashing and the liquid fraction may be directed to be combined with the hydrocracked bottom fraction (106) as recycle, such that the recycled deoxygenated hydrocarbon mixture functions as a heat sink for the heat developed in the exothermal deoxygenation reaction.

In addition to this specific layout, alternative layouts may also be relevant, including a layout in which no hydrocracking section is included, or a layout where the hydrocracking section (HDC) is positioned between the deoxygenation section (DO) and the fractionation section (FRAC). Also in these layouts a recycle may be used as heat sink.

### EXAMPLES

Two examples are presented to show the effect of the present disclosure.

### Example 1

In a first example, two catalytically active materials compared on similar feedstock, for evaluation of the selectivity with respect to decarboxylation and hydrodeoxygenation.

Example 1 A involves reaction of a renewable feedstock here denoted Feed A having a fatty acid composition shown in Table 1, reacted in the presence of a catalytically active material (NiMoS), comprising 2.6 wt % Ni and 13 wt % Mo, and Example 1 B involves reaction of a renewable feedstock denoted Feed B, having a fatty acid composition shown in Table 1 reacted in the presence of a catalytically active material (NS), comprising 15 wt % Ni and a small amount, 0.3 wt %, Mo. In both cases the catalytically active material was sulfided, and an amount of dimethyl disulfide was added to the stream of reactants.

Examples 1A and 1B evaluate the reaction of the feedstock in a single deoxygenation reactor. Reaction conditions are also shown in Table 2, corresponding to the mildest severity ensuring removal of oxygen to below 2000 ppmwt in the feedstock. While the properties of Feed A and Feed B are different, and minor differences exist between the conditions of Experiment 1A and 1B, the similarities between the two experiments are sufficient for considering the results representative for the difference between the two catalytically active materials, which is seen to be that NiS is only 30% selective towards hydrodeoxygenation, whereas NiMoS is 90% selective towards hydrodeoxygenation, while the NiS-based catalytically active material requiring more severe conditions.

TABLE 1

| | Unit | Feed A | Feed B |
|---|---|---|---|
| C8:0 | Area % GC-AED | 0.07 | 0.00 |
| C10:0 | Area % GC-AED | 0.04 | 0.00 |
| C12:0 | Area % GC-AED | 0.11 | 0.00 |
| C14:0 | Area % GC-AED | 0.88 | 0.08 |
| C14:1 | Area % GC-AED | 0.13 | 0.00 |
| C15:0 | Area % GC-AED | 0.11 | 0.00 |
| C16:0 | Area % GC-AED | 16.40 | 10.92 |
| C16:1 | Area % GC-AED | 1.45 | 0.10 |
| C17:1 | Area % GC-AED | 0.20 | 0.00 |
| C18:0 | Area % GC-AED | 6.05 | 2.92 |
| C18:1 | Area % GC-AED | 35.56 | 23.33 |
| C18:2 | Area % GC-AED | 34.98 | 52.83 |
| C18:3 | Area % GC-AED | 1.80 | 5.86 |
| C20:0 | Area % GC-AED | 0.37 | 0.41 |
| C20:1 | Area % GC-AED | 0.42 | 0.32 |
| C20:2 | Area % GC-AED | 0.20 | 0.00 |
| C21:0 | Area % GC-AED | 0.15 | 0.00 |
| C22:0 | Area % GC-AED | 0.14 | 0.41 |
| C22:1 | Area % GC-AED | 0.10 | 0.00 |
| C23:0 | Area % GC-AED | 0.06 | 0.00 |
| C24:0 | Area % GC-AED | 0.05 | 0.17 |
| Unknown | Area % GC-AED | 0.73 | 2.64 |
| compound | | | |

TABLE 2

| Test | | A | B |
|---|---|---|---|
| Feed | Unit | Feed A | Feed B |
| Gas/oil ratio | Nl/l | 952 | 1500 |
| Pressure | barg | 64 | 90 |
| Hydrogen consumption | Nl/l | 385 | 283 |
| LHSV PRE | h⁻¹ | | 0.75 |
| WABT PRE | ° C. | | 210 |
| Oxygen removed in PRE | % | | 12 |
| HDO selectivity PRE | % | | 72 |
| HYD of olefins PRE | % | | 95 |
| LHSV DO | h⁻¹ | 0.505 | 0.5 |
| WABT DO | ° C. | 302 | 330 |
| Oxygen removed in DO | % | 100 | 100 |
| HYD of olefins DO | % | 100 | 100 |
| HDO selectivity DO | % | 90 | 30 |

### Example 2

Example 2 compares the practical process design using the two types of catalytically active material in a layout corresponding to FIG. 1, but without isomerization, i.e. assuming 124 as the product. For comparison a the process design was also calculated using a third type of catalytically active material, taken from EP1681337B, 5 wt % Pd/C, having a selectivity for decarboxylation of 97%, corresponding to a ratio between decarboxylation and hydrodeoxygenation of 32:1. In this example it was assumed that the feed consisted of C18:2, C18:1, C16:0 with a molar ratio of 3:2:1, corresponding largely to sunflower oil. A detailed overview of the stream composition for the different cases are shown in Table 3-Table 6.

For simplicity the examples assume a cooled reactor. In practice the temperature in the deoxygenation section (DO) would be limited by cooling an amount of deoxygenated hydrocarbon mixture (112) and combining it with the hydrocracked bottom fraction (106), to provide a heat sink.

Example 2A (Table 3) and Example 2B (Table 4) demonstrate the performance with a NiS based catalyst, corresponding to Example 1B. Table 3. Example 2A assumes an ideal configuration of the pre-hydrogenation reactor (PRE), with 100% hydrogenation of olefins, but no deoxygenation, whereas Example 2B corresponds to Example 1B, with 12% deoxygenation, with a hydro-deoxygenation selectivity of 72%. Both Example 2A and 2B assume 30% hydro-deoxygenation and 70% decarboxylation in the deoxygenation reactor.

Example 2C (Table 5) demonstrate the performance with a NiMoS based deoxygenation catalyst similar to that of Example 1A, but with 95% pre-hydrogenation as in Examples 1B and 2B, with 12% deoxygenation, with a hydro-deoxygenation selectivity of 72%. Example 2C assumes 30% hydro-deoxygenation and 70% decarboxylation in the deoxygenation reactor.

Example 2D (Table 6) demonstrate the performance with a 5 wt % Pd/C based catalyst as reported in EP1681337B, having a selectivity for decarboxylation of 97% and with 95% pre-hydrogenation as in Examples 1B, 2B and 2C, with 12% deoxygenation with a hydro-deoxygenation selectivity of 72%. Example 2D assumes 3% hydro-deoxygenation and 97% decarboxylation in the deoxygenation reactor, and otherwise a performance similar to Example 1B.

An overview of the performance of Examples 2A-2D is shown in Table 7. It is clearly shown that for a catalyst with high decarboxylation selectivity (2B and 2D) aviation fuel yield is 5.2% or even 7.5% higher than that of example 2C, while the hydrogen consumption is lower.

TABLE 3

| | | 100 | 102 | 104 | 112 | 126 | 106 |
|---|---|---|---|---|---|---|---|
| Flow | kg/h | 100.0 | 100.0 | 120.0 | 120.0 | 20.0 | 20.0 |
| Olefins | wt % | 74.18 | 0.00 | 0.00 | 0.00 | 0.00 | 0.00 |
| H₂ | wt % | 12.09 | 11.28 | 9.91 | 8.71 | 3.81 | 3.05 |
| CO, CO₂ | wt % | 0.00 | 0.00 | 0.00 | 6.00 | 0.00 | 0.00 |
| C₁₋₄ | wt % | 0.00 | 0.00 | 0.00 | 3.77 | 0.00 | 0.00 |
| Naphtha | wt % | 0.00 | 0.00 | 2.72 | 2.72 | 0.00 | 16.29 |
| (C₅₋₇) | | | | | | | |
| Jet yield | wt % | 0.00 | 0.00 | 12.85 | 57.45 | 0.00 | 77.01 |
| (C₈₋₁₇) | | | | | | | |
| Heavy (C₁₈) | wt % | 0.00 | 0.00 | 0.00 | 16.05 | 96.19 | 0.00 |
| C5-160° C. | wt % | 0.00 | 0.00 | 6.61 | 6.61 | 0.00 | 39.64 |
| 160° C.- | wt % | 0.00 | 0.00 | 8.95 | 53.55 | 0.00 | 53.65 |
| 300° C. | | | | | | | |
| >300° C. | wt % | 0.00 | 0.00 | 0.00 | 16.05 | 96.19 | 0.00 |

TABLE 4

| | | 100 | 102 | 104 | 112 | 126 | 106 |
|---|---|---|---|---|---|---|---|
| Flow | kg/h | 100.0 | 100.0 | 123.4 | 123.4 | 23.4 | 23.4 |
| Olefins | wt % | 74.18 | 3.71 | 3.01 | 0.00 | 0.00 | 0.00 |
| H₂ | wt % | 12.09 | 11.07 | 9.55 | 8.49 | 3.81 | 3.05 |
| CO, CO₂ | wt % | 0.00 | 0.31 | 0.25 | 5.42 | 0.00 | 0.00 |
| C₁₋₄ | wt % | 0.00 | 74.99 | 62.47 | 0.00 | 0.00 | 0.00 |
| Naphtha | wt % | 0.00 | 0.00 | 3.09 | 3.09 | 0.00 | 16.29 |
| (C₅₋₇) | | | | | | | |
| Aviation fuel | wt % | 0.00 | 3.40 | 17.36 | 55.53 | 0.00 | 77.01 |
| yield (C₈₋₁₇) | | | | | | | |
| Heavy (C₁₈) | wt % | 0.00 | 5.55 | 4.50 | 18.24 | 96.19 | 0.00 |
| C5-160° C. | wt % | 0.00 | 0.00 | 7.52 | 7.52 | 0.00 | 39.64 |
| 160° C.- | wt % | 0.00 | 3.40 | 12.93 | 51.10 | 0.00 | 53.65 |
| 300° C. | | | | | | | |
| >300° C. | wt % | 0.00 | 5.55 | 4.50 | 18.24 | 96.19 | 0.00 |

TABLE 5

| | | 100 | 102 | 104 | 112 | 126 | 106 |
|---|---|---|---|---|---|---|---|
| Flow | kg/h | 100.0 | 100.0 | 158.6 | 158.6 | 58.6 | 58.6 |
| Olefins | wt % | 74.18 | 3.71 | 2.34 | 0.00 | 0.00 | 0.00 |
| H₂ | wt % | 12.09 | 11.07 | 8.10 | 6.78 | 3.81 | 3.05 |
| CO, CO₂ | wt % | 0.00 | 0.31 | 0.19 | 0.73 | 0.00 | 0.00 |
| C₁₋₄ | wt % | 0.00 | 0.54 | 0.34 | 2.91 | 0.00 | 0.00 |
| Naphtha | wt % | 0.00 | 0.00 | 6.02 | 6.02 | 0.00 | 16.29 |
| (C₅₋₇) | | | | | | | |
| Aviation fuel | wt % | 0.00 | 3.40 | 30.61 | 40.35 | 0.00 | 77.01 |
| yield (C₈₋₁₇) | | | | | | | |
| Heavy (C₁₈) | wt % | 0.00 | 5.55 | 3.50 | 35.56 | 96.19 | 0.00 |
| C5-160° C. | wt % | 0.00 | 0.00 | 14.65 | 14.65 | 0.00 | 39.64 |
| 160° C.- | wt % | 0.00 | 3.40 | 21.98 | 31.71 | 0.00 | 53.65 |
| 300° C. | | | | | | | |
| >300° C. | wt % | 0.00 | 5.55 | 3.50 | 35.56 | 96.19 | 0.00 |

TABLE 6

| | | 100 | 102 | 104 | 112 | 126 | 106 |
|---|---|---|---|---|---|---|---|
| Flow | kg/h | 100.0 | 100.0 | 107.5 | 107.5 | 7.5 | 7.5 |
| Olefins | wt % | 74.18 | 3.71 | 3.45 | 0.00 | 0.00 | 0.00 |
| H₂ | wt % | 12.09 | 11.07 | 10.51 | 9.61 | 3.81 | 3.05 |
| CO, CO₂ | wt % | 0.00 | 0.31 | 0.28 | 8.49 | 0.00 | 0.00 |
| C₁₋₄ | wt % | 0.00 | 0.54 | 0.50 | 4.22 | 0.00 | 0.00 |
| Naphtha | wt % | 0.00 | 0.00 | 1.14 | 1.14 | 0.00 | 16.29 |
| (C₅₋₇) | | | | | | | |
| Aviation fuel | wt % | 0.00 | 3.40 | 8.56 | 65.61 | 0.00 | 77.01 |
| yield (C₈₋₁₇) | | | | | | | |
| Heavy (C₁₈) | wt % | 0.00 | 5.55 | 5.16 | 6.74 | 96.19 | 0.00 |
| C5-160° C. | wt % | 0.00 | 0.00 | 2.78 | 2.78 | 0.00 | 39.64 |
| 160° C.- | wt % | 0.00 | 3.40 | 6.92 | 63.98 | 0.00 | 53.65 |
| 300° C. | | | | | | | |
| >300° C. | wt % | 0.00 | 5.55 | 5.16 | 6.74 | 96.19 | 0.00 |

TABLE 7

| | | A | B | C | D |
|---|---|---|---|---|---|
| DCO catalyst | | NiS | NiS | NiMOS | Pd/C |
| HYD PRE reactor | % | 100 | 95 | 95 | 95 |
| DO PRE reactor | % | 0 | 12 | 12 | 12 |
| HDO selectivity | % | 72 | 72 | 72 | 72 |
| PRE reactor | | | | | |
| HYD DO reactor | % | 100 | 100 | 100 | 100 |
| DO DO reactor | % | 100 | 100 | 100 | 100 |
| HDO selectivity | % | 30 | 30 | 90 | 3 |
| DCO reactor | | | | | |
| CO, CO₂ yield | wt % | 8.2 | 7.6 | 1.3 | 10.4 |
| C₁₋₄ yield | wt % | 5.1 | 5.1 | 5.3 | 5.2 |
| Naphtha yield (C₅₋₇) | wt % | 3.7 | 4.3 | 10.9 | 1.4 |
| Aviation fuel yield | wt % | 78.4 | 78.0 | 72.8 | 80.3 |
| (C₈₋₁₇) | | | | | |
| Hydrogen consumption | g/kg | 27 | 29 | 41 | 23 |

1. A method for producing a hydrocarbon mixture having an end-boiling point according to ASTM D86 below 300° C. and being suitable for use as an aviation fuel from a decarboxylation feedstock comprising fatty acid esters and/or triglycerides and wherein at least 40% of the carbon atoms of the decarboxylation feedstock are contained in C18 side-chains, by converting said decarboxylation feedstock in in the presence of a material catalytically selective towards decarboxylation, such that the ratio between deoxygenation by formation of carbon oxides and deoxygenation by formation of water is at least 1.5:1, as measured by the ratio of C17 paraffins to C18 paraffins in the deoxygenated hydrocarbon mixture.

2. A method according to claim 1 where decarboxylation conditions involve a temperature in the interval 250-400° C., a pressure in the interval 30-150 bar, and a liquid hourly space velocity (LHSV) in the interval 0.1-2 and wherein the material catalytically active in decarboxylation comprises nickel optionally in combination with other metals, supported on a carrier comprising one or more refractory oxides.

3. A method according to claim 1, wherein at least 60% or 80% of the carbon atoms of said decarboxylation feedstock is contained in C18 side chains.

4. A method according to claim 1, wherein the material catalytically active in decarboxylation comprises more than 5 wt % Ni, and less than 1 wt %, Co, Mo and W.

5. A method according to claim 1, wherein said decarboxylation feedstock is a saturated decarboxylation feedstock, comprising less than 10 wt % olefinic oxygenates.

6. A method according to claim 5, wherein said saturated decarboxylation feedstock is provided as the product of a hydrogenation reaction, receiving a raw oxygenate feedstock comprising at least 10 wt % olefinic oxygenates and selectively hydrogenating olefinic oxygenates under olefin pre-hydrogenation conditions, to provide said saturated decarboxylation feedstock.

7. A method according to claim 6 where pre-hydrogenation conditions involve a temperature in the interval from 150° C. to 280° C., a pressure in the interval 30-150 bar, and a liquid hourly space velocity (LHSV) in the interval 0.1-2 and wherein the material catalytically active in pre-hydrogenation comprises 5 wt % to 20 wt % molybdenum or tungsten, in combination with 1 wt % to 5 wt % nickel and/or cobalt, supported on a carrier comprising one or more refractory oxides.

8. A method according to claim 1, comprising separating the deoxygenated hydrocarbon mixture according to boiling point, to provide a hydrocracked intermediate aviation fuel having T10 below 205° C. and final boiling point below 300° C. according to ASTM D86.

9. A method according to claim 1, wherein the total volume of hydrogen sulfide relative to the volume of molecular hydrogen in the gas phase of the total stream directed to contact the material catalytically active in decarboxylation is at least 50 ppmv, optionally originating from an added stream comprising one or more sulfur compounds.

10. A method according to claim 1, wherein said decarboxylation feedstock comprises at least 50% wt triglycerides or fatty acids.

11. A method according to claim 1, further comprising a hydrocracking step, under active hydrocracking conditions, where the deoxygenated hydrocarbon mixture or a mixture derived therefrom is directed to contact a material catalytically active in hydrocracking.

12. A method according to claim 11, wherein hydrocracking conditions involve a temperature in the interval 300-450° C., a pressure in the interval 30-150 bar, and a liquid hourly space velocity (LHSV) in the interval 0.5-8 and wherein the material catalytically active in hydrocracking comprises an active metal taken from the group comprising platinum, palladium, nickel, cobalt, tungsten and molybdenum, an acidic support being one or more of an amorphous acidic oxides, and a molecular sieve showing high cracking activity.

13. A method according to claim 1, further comprising an isomerization step, under active isomerization conditions involves a temperature in the interval 250-350° C., a pressure in the interval 30-150 bar, and a liquid hourly space velocity (LHSV) in the interval 0.5-8 and wherein the material catalytically active in isomerization comprises an active metal taken from the group comprising platinum, palladium, nickel, cobalt, tungsten and molybdenum, a molecular sieve showing high isomerization selectivity.

14. A process plant for production of a hydrocarbon fraction from an decarboxylation feedstock, said process plant comprising a decarboxylation section, a hydrocracking section and a fractionation section, said process plant being configured for directing the decarboxylation feedstock in combination with an amount of a hydrocracked intermediate product to the decarboxylation section to provide a deoxygenated hydrocarbon mixture, separating the deoxygenated hydrocarbon mixture in said fractionation section to provide at least two fractions, including a low boiling product fraction and a high boiling product fraction, directing at least an amount of the high boiling product fraction to the hydrocracking section to provide a hydrocracked intermediate product, directing at least an amount of said hydrocracked intermediate product to the decarboxylation section, wherein said decarboxylation section contains a catalytically active material comprising less than 1 wt %, Co, Mo or W.
